(19) United States
(12) Patent Application Publication
(10) Pub. No.: US 2024/0043744 A1
(43) Pub. Date: Feb. 8, 2024

(54) NANOPOROUS CERIUM OXIDE NANOPARTICLE MACRO-STRUCTURES AS AUTOXIDATION INHIBITORS

(71) Applicants: Xheme Inc., Newton, MA (US); Alma Mater Studiorum-Universita di Bologna, Bologna (IT)

(72) Inventors: Riccardo Amorati, Bologna (IT); Siva Sai Ramana Kumar Challa, Newton, MA (US)

(21) Appl. No.: 17/817,858

(22) Filed: Aug. 5, 2022

(51) Int. Cl. C09K 15/02; C09K 15/04; C08K 3/22; C08K 5/01

(52) U.S. Cl. CPC C09K 15/02; C09K 15/04; C08K 3/22; C08K 5/01; C08K 2003/2213; C08K 2201/012; C08K 2201/011; C08K 2201/005

(57) ABSTRACT

The present invention stands directed at the use of nanoporous cerium oxide nanoparticle macro-structures as autoxidation inhibitors of organic compounds susceptible to autoxidation. The nanoporous cerium oxide nanoparticle macrostructures are more specifically employed in combination with a co-antioxidant.

### FIELD

The present invention stands directed at the use of nanoporous cerium oxide nanoparticle macro-structures as autoxidation inhibitors of organic substrates susceptible to autoxidation. The nanoporous cerium oxide nanoparticle macrostructures are more specifically employed in combination with a co-antioxidant.

### BACKGROUND

Autoxidation of organic materials refers to their spontaneous reaction with O₂ and represents a significant hurdle in disparate fields ranging from petrochemistry, food storage and biomedical application. In the last 70 years, many antioxidant strategies have been put forward. These include the use of synthetic additives including phenols, aromatic amines, sulphides and phosphines. More recently antioxidants have employed the use of natural inhibitors with a food-grade or generally recognized as safe (GRAS) status for applications linked to the food and pharmaceutical industry.

Organic antioxidants, synthetic or natural, can play three different roles based on their mechanism. While the primary antioxidants function essentially as free radical terminators (scavengers), the secondary antioxidants are more likely to be preventive antioxidants that function by retarding chain initiation. On the other hand, the so-called tertiary antioxidants are concerned with the induction of enzymatic defences in vivo and with repair of damaged biomolecules. The tendency to replace synthetic antioxidants with natural ones must face the relatively lower activity and the relatively higher cost of the latter ones, which implies that novel strategies to achieve the same potency remain to be implemented.

### SUMMARY

An autoxidation composition to inhibit autoxidation of an organic compound susceptible to autoxidation comprising: (1) a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm; and (2) a co-antioxidant compound comprising an organic compound hydrogen donor that provides for an abstraction of hydrogen by a peroxy radical ROO·, where R is reference to organic alkyl or organic aromatic type functionality.

A stabilized composition comprising (1) a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm; (2) a co-antioxidant compound comprising an organic compound hydrogen donor that provides for an abstraction of hydrogen by a peroxy radical ROO·, where R is reference to organic alkyl or organic aromatic type functionality; and (3) an organic compound susceptible to autoxidation.

A method for reducing the autoxidation of an organic compound susceptible to autoxidation, comprising: (1) supplying nanoporous cerium oxide nanoparticle (NCeONP) macro-structure comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm; (2) supplying a co-antioxidant compound comprising an organic compound hydrogen donor that provides for an abstraction of hydrogen by the free radical ROO· and R is reference to organic alkyl or organic aromatic type functionality; and (3) placing said nanoporous cerium oxide nanoparticle macro-structure and said co-antioxidant into said organic compound susceptible to autoxidation to reduce autoxidation.

### BRIEF DESCRIPTION OF THE DRAWINGS

Aspects of the present disclosure may be appreciated upon review of the description herein and the accompanying drawings which identify as follows:

FIG. 1 illustrates cerium oxide nanoparticles.

FIG. 2 illustrates the nanoporous cerium oxide nanoparticle (NCeONP) macro-structure formed from the cerium oxide nanoparticles illustrated in FIG. 1.

FIG. 3 is a scanning electron micrograph of the cerium oxide nanoparticles employed to form the nanoporous cerium oxide nanoparticle macro-structure.

FIG. 4A is a scanning electron micrograph of the nanoporous cerium oxide nanoparticle micro-structure at the indicated magnification.

FIG. 4B is another scanning electron micrograph of the nanoporous cerium oxide nanoparticle micro-structure at the indicated magnification.

FIG. 4C is another scanning electron micrograph of the nanoporous cerium oxide nanoparticle micro-structure at the indicated magnification.

FIG. 5 illustrates the O₂ consumption rate during the autoxidation of styrene (2.2 M) initiated by AIBN (25 mM) at 30° C. in MeCN (a) without inhibitors or in the presence of: (b) NCeONP macro-structures 0.25 mg/mL; (c) γ-T 16 mM; (d) NCeONP macro-structures 1.0 mg/mL; (e) NCeONP macro-structures 0.25 mg/mL+γ-T 16 mM; (f) NCeONP macro-structures 1.0 mg/mL+γ-T 16 mM.

FIG. 6A illustrates the O₂ consumption rate measured during the autoxidation of styrene (4.3 M) in MeCN initiated by AIBN (25 mM); (A) with increasing NCeONP macro-structures in absence (O) or in presence (•) of γ-T (16 mM).

FIG. 6B illustrates the O₂ consumption rate measured during the autoxidation of styrene (4.3 M) in MeCN initiated by AIBN (25 mM) with increasing γ-T in absence (O or open circle plotted points) or in presence (• or closed circle plotted points) of NCeONP macro-structures (0.25 mg/mL).

FIG. 7 illustrates the O₂ consumption rate for styrene autoxidation in the presence of the NCeONP macro-structures herein with respect to other metal oxides, namely TiO₂ (anatase), TiO₂ (rutile), ZnO, ZrO₂, and cerium oxide nanoparticles, at two representative concentrations of the metal oxide, namely 0.25 mg/mL and 1.0 mg/mL, with and without the presence of 0.25 mg/mL or 1.0 mg/mL of (γ-terpinene).

FIG. 8 provides in plot “a” the UV absorption of: tert-butylhydroquinnone ((labelled QH₂) at 0.18 mM. Plot “b” is for the identified quinone structure (labelled Q) at 0.18 mM, and plot “c” is the UV absorption of the mixture QH₂ and NCeONP macro-structures herein at 0.18 mM/1 mg/ml after four (4) hours of reaction.

FIG. 9 which provides the relative concentration of the indicated compounds after the reaction with QH₂ according to the procedure of FIG. 8.

### DETAILED DESCRIPTION OF THE PREFERRED EMBODIMENTS

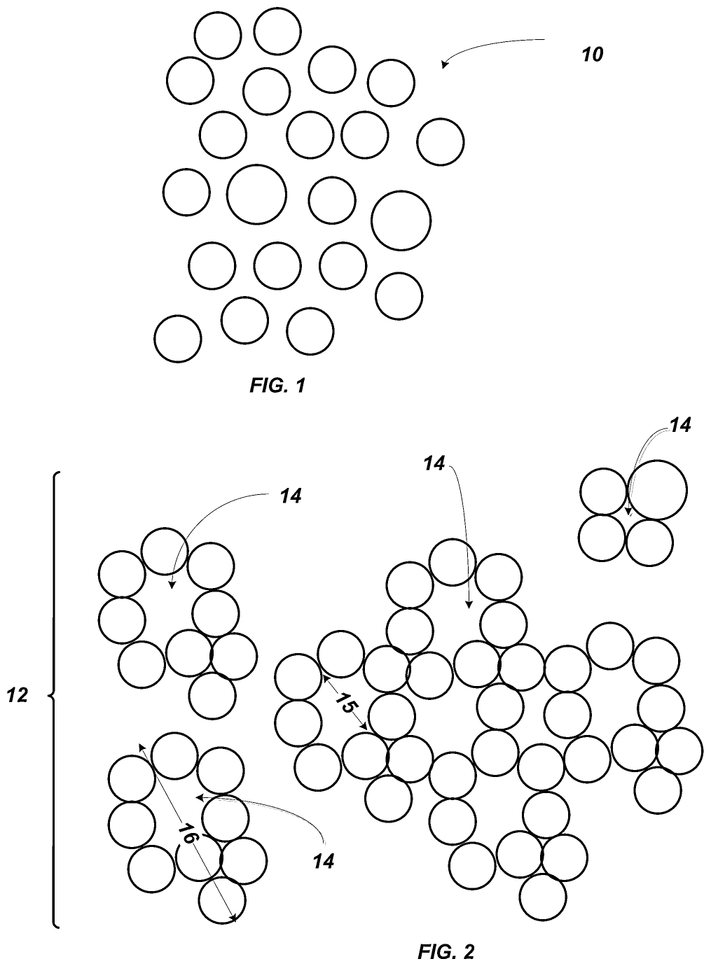

The present invention stands directed at nanoporous cerium oxide nanoparticle (NCeONP) macro-structure. Reference to a macro-structure is reference to the feature that a plurality of the particles associate or adhere to one another where the macro-structure has its own pore size diameter. With attention to FIG. 1, preferably, the starting cerium oxide nanoparticles 10 preferably have a diameter (largest linear dimension) in the range of 10 nm to 100 nm. More preferably, the cerium oxide nanoparticles employed herein have a diameter in the range of 10 nm to 50 nm or 10 nm to 30 nm or 20 nm to 30 nm.

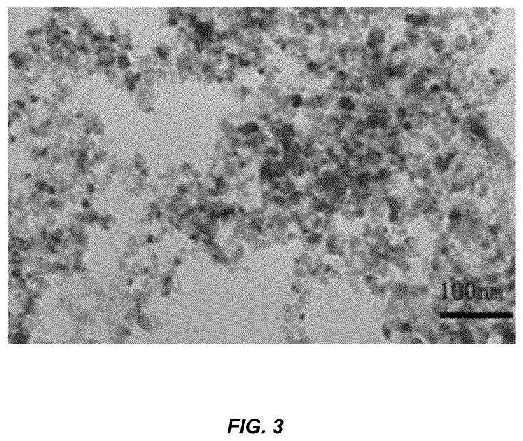

The above referenced cerium oxide nanoparticles are then preferably degassed with nitrogen for a preferred period of 30 minutes to 60 minutes. This is then preferably followed by heating at elevated temperature, and preferably at the temperature range of 50° C. to 900° C. for a preferred period of 1.0 hour to 3.0 hours, more preferably 1.0 hour to 2.0 hours. Accordingly, such heating of the cerium oxide nanoparticles was observed to form a plurality of nanoporous cerium oxide nanoparticle macro-structures 12 illustrated in FIG. 2 having macro-structure pores 14.

The macro-structure pores 14 that are formed by the cerium oxide nanoparticle macrostructure 12 preferably have a diameter (largest linear dimension) as indicated by arrow 15 in the range of 10 nm to 1100 nm, more preferably, 10 nm to 750 nm or 10 nm to 500 nm or 10 nm to 250 nm or 10 nm to 100 nm or 10 nm to 50 nm or 10 nm to 25 nm. In addition, the nanoporous cerium oxide nanoparticle macro-structures 12 themselves are contemplated to have a preferred diameter (largest linear dimension) as indicated by arrow 16 in the range of 50 nm to 30,000 nm.

In one particular preferred embodiment, the nanoporous cerium oxide nanoparticle macro-structures (NCeONP) that are formed herein have a binary size distribution with respect to both their macro-structure diameter 16 and macro-structure pore diameter 15. A binary size distribution is reference to two distributions of size ranges for both the macro-structure diameter and macro-structure pore diameter. That is, the preparation methods herein preferably provide a nanoporous cerium oxide nanoparticle macro-structure that has the following binary size distribution: (1) macro-structure diameter in the range of 10 nm to 300 nm with a macro-structure pore diameter in the range of 5 nm to 30 nm, more preferably 10 nm to 20 nm; and (2) macro-structure diameter in the range of 5,000 nm to 30,000 nm with a macro-structure pore diameter in the range of 900 nm to 1100 nm.

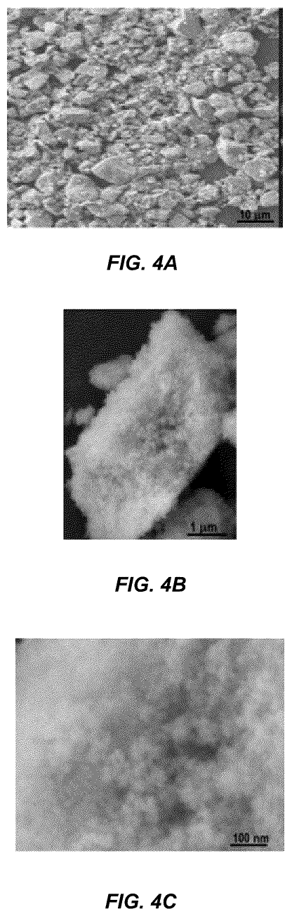

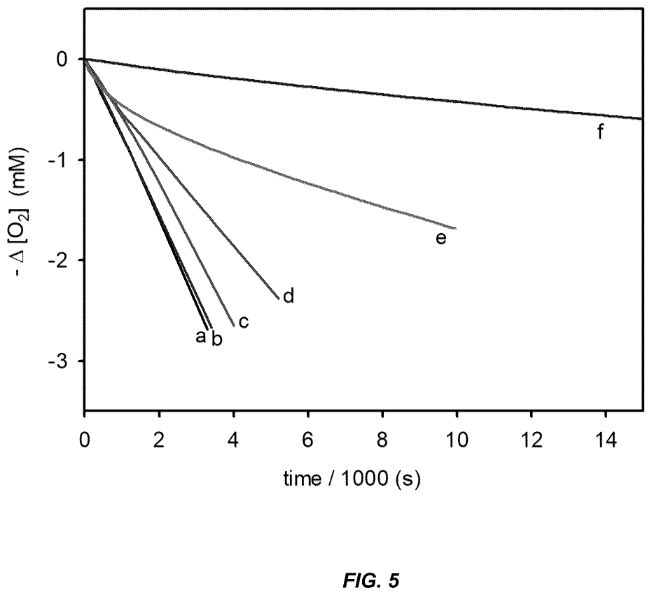

FIG. 3 is a scanning electron micrograph of the cerium oxide nanoparticles employed herein to form the nanoporous cerium oxide nanoparticle macro-structure. As noted above, such starting cerium oxide nanoparticles preferably had a diameter of 20 nm to 30 nm. FIGS. 4A, 4B and 4C, respectively, provide scanning electron micrographs at increasing magnification showing the nanoporous cerium oxide nanoparticle macro-structure herein formed from the cerium oxide nanoparticles of FIG. 3, wherein the macro-structure itself forms macro-structure pores 14 (see again FIG. 1).

The nanoporous cerium oxide nanoparticle (NCeONP) macro-structure herein was next employed to inhibit the autoxidation of organic compounds or substrates susceptible to autoxidation, where such organic substrates (RH) are prone to react with free-radicals in the presence of oxygen and generation of peroxyl radicals (ROO·), by considering a representative organic substrate of styrene. However, in the broad context of the present invention, the organic substrates herein for which autoxidation is now inhibited, is again contemplated to be any organic substrate (RH) where hydrogen is abstracted by a free radical or where double bonds undergo addition by a free radical, forming, in the presence of oxygen, a new radical that propagates the oxidative chain. Such organic substrates may therefore include organic compounds that have, e.g., a tertiary, secondary or even primary hydrogen that is abstracted by a free radical, and includes various polymeric compounds that are susceptible to autoxidation (e.g., polyethylene, polypropylene, poly(vinyl chloride), polystyrene, including unsaturated polymers (e.g., polyisoprene and polybutadiene) as well as branched polymers. Along such lines, it can be appreciated that the polymers that are susceptible to autoxidation are those that include one or more tertiary secondary or primary hydrogen atoms that are susceptible to abstraction by a free-radical.

The nanoporous cerium oxide nanoparticle (NCeONP) macro-structures herein demonstrated that it performed as an oxidation inhibitor in the presence of a synergistic co-antioxidant. The co-antioxidant is reference to a compound that itself preferably reacts with the peroxyl radical (ROO·) and donates a hydrogen and reacts with oxygen and then generates HOO· radicals. R is reference to organic alkyl or organic aromatic type functionality. The co-antioxidant herein may therefore preferably be understood as any organic compound hydrogen donor that initially provides for an abstraction of hydrogen by the peroxy radical ROO·. Co-antioxidants may therefore preferably include pro-aromatic compounds such as 1,4-cyclohexadiene or 1,3-cyclohexadiene compounds, organic alcohol compounds, hydroquinone compounds, unsaturated hydrocarbon compounds, primary, secondary and tertiary alkylamine compounds, 1,4-dihyrdopyridines, 4-substituted Hantzsch esters, 2,3- and 2,5-dihydrofurane, and/or 1,2- and 1,4-dihydronaphthalene. Reference to a pro-aromatic compound is reference to a compound that can loose hydrogen (H₂) and become aromatic.

Preferably, the level of the nanoporous cerium oxide nanoparticle (NCeONP) macro-structures herein in the organic substrates, to inhibit autoxidation, is at a level of 0.1% (wt.) to 5.0% (wt.), including all individual values and increments therein. In addition, the preferred level of the co-antioxidant is similarly at a level of 0.1% (wt.) to 5.0% (wt.) in the organic substrate that requires protection from autoxidation, including all individual values and increments therein.

More specifically, the antioxidant activity of the nanoporous cerium oxide nanoparticle (NCeONP) macro-structure was confirmed by measuring the ability to slow down the autoxidation of styrene, a representative organic oxidizable substrate, initiated by the thermal decomposition of azobis(isobutyronitrile) at 30° C. in acetonitrile. Styrene autoxidation follows the typical mechanism of the autoxidation of organic compounds, consisting of the initiation, propagation, and termination steps which involve carbon (R·) and oxygen-centered peroxyl (ROO·) radicals. The addition of the nanoporous cerium oxide nanoparticle (NCeONP) macro-structures herein along with γ-terpinene (γ-T) as a representative co-antioxidant herein, each at the preferred levels of 0.1% (wt.) to 5.0% (wt.) relative to styrene, generates HOO· radicals into the system, through the cascade reactions, now illustrated in Scheme 1 below, which illustrates the autoxidation of the representative organic compound of styrene (RH) indicated by AIBN derived radicals (In·) and generation of hydroperoxyl radicals by the co-oxidation of γ-terpinene (γ-T) forming para-cymene (p-Cy).

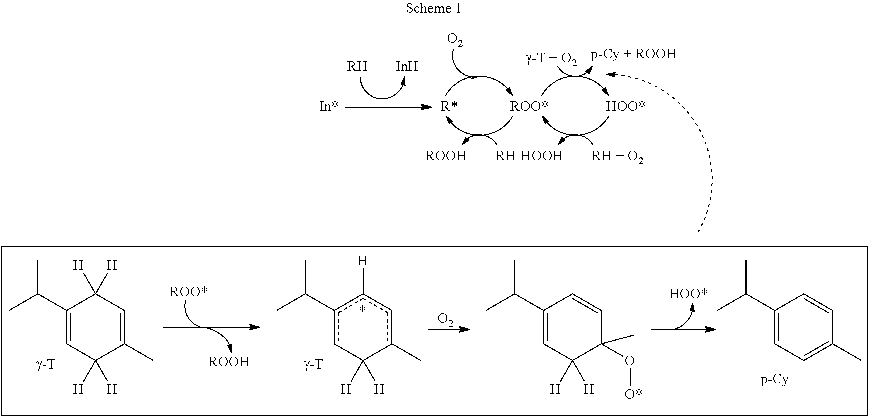

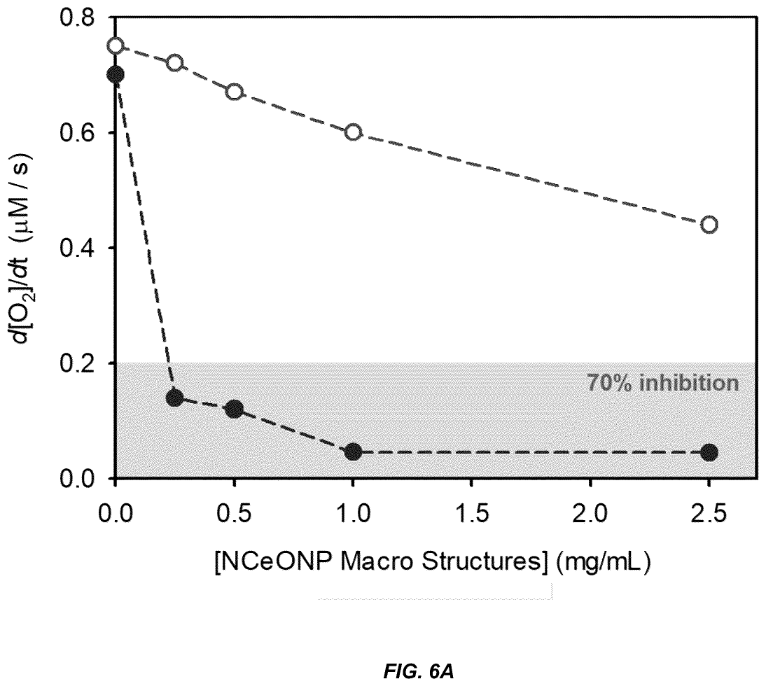

The rate of styrene or styrene/γ-T autoxidation was next determined by measuring the O₂ consumption in a close reaction vessel. Reference is therefore made to FIG. 5, which illustrates the O₂ consumption rate during the autoxidation of styrene (2.2 M) initiated by AIBN (25 mM) at 30° C. in MeCN (a) without inhibitors or in the presence of: (b) NCeONP macro-structures 0.25 mg/mL; (c) γ-T 16 mM; (d) NCeONP macro-structures 1.0 mg/mL; (e) NCeONP macro-structures 0.25 mg/mL+γ-T 16 mM; (f) NCeONP macro-structures 1.0 mg/mL+γ-T 16 mM. In the absence of antioxidants, O₂ consumption is relatively fast and linear (see line a in FIG. 5) while upon the addition of an antioxidant, the O₂ consumption is reduced proportionally to the efficiency of ROO· or ROO·/HOO· trapping (see FIG. 5, lines d-f).

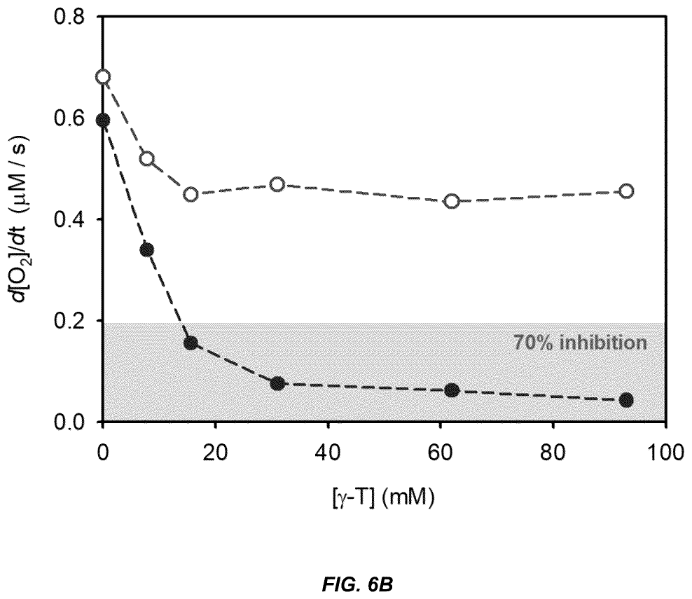

Reference is next made to FIG. 6A which illustrates the O₂ consumption rate measured during the autoxidation of styrene (4.3 M) in MeCN initiated by AIBN (25 mM); (A) with increasing NCeONP macro-structures in absence (O or open circle plotted points) or in presence (• or solid circle plotted points) of γ-T (16 mM). FIG. 6B illustrates the 02 consumption rate measured during the autoxidation of styrene (4.3 M) in MeCN initiated by AIBN (25 mM) with increasing γ-T in absence (O or open circle plotted points) or in presence (• or closed circle plotted points) of NCeONP macro-structures (0.25 mg/mL).

As may therefore be appreciated from the above, the NCeONP macro-structures were a relatively poor inhibitor of the autoxidation of styrene when used alone, as can be observed by comparing the slopes of the traces of lines “a” and “b” in FIG. 5. By contrast, the presence of the NCeONP macro-structures herein with a representative co-antioxidant, which as noted is any organic compound hydrogen donor that provides for an abstraction of hydrogen by the free radical ROO·, resulted in inhibition of the autoxidation, as illustrated in FIG. 5, lines “e” and “f”. The degree of inhibition was observed to be dependent upon the concentration of the NCeONP macro-structures and the representative co-antioxidant (γ-terpinene) with an observed reduction in O₂ consumption rate of at least 80% or greater, more preferably 90% or greater, or even 95% or greater. Stated another way, NCeONP macro-structures, in combination with a co-antioxidant, when employed as an additive for the reduction in autoxidation of organic compounds susceptible to autoxidation, are contemplated to reduce the O₂ consumption rate by at least 80% or greater, more preferably 90% or greater, or 95% or greater, than the consumption of O₂ observed in the absence of the NCeONP macro-structures in combination with a co-antioxidant.

Without being bound by theory, it is noted that the potential mechanism of antioxidant action herein may be explained by invoking the reactions reported in Scheme 2 below. First, CeO₂ in the NCeOMP macro-structures reacts with HOO· by accepting a H-atom and is contemplated to form a reduced specie that in turn reacts with a ROO· (or HOO·) radical back to CeO₂. Following this line of reasoning, CeO₂ in the macrostructures may work as catalytic antioxidant being able to accelerate the HOO·/ROO· decomposition without being consumed during the reaction.

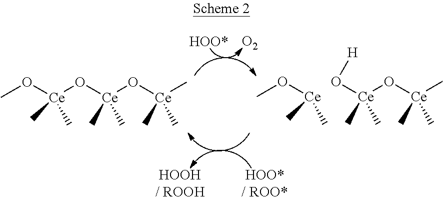

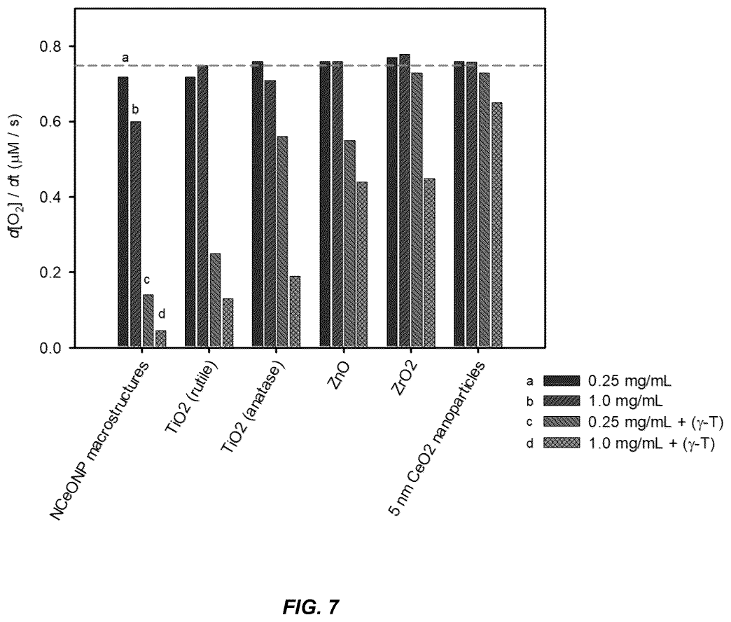

A comparison was also conducted to evaluate the behavior of the NCeONP macro-structures herein with respect to other metal oxides, namely TiO₂ (anatase), TiO₂ (rutile), ZnO, ZrO₂, and 5 nm cerium oxide nanoparticles, at two representative concentrations of the metal oxide, namely 0.25 mg/mL and 1.0 mg/mL, with and without the presence of 0.25 mg/mL or 1.0 mg/mL of (γ-terpinene). The O₂ consumption rate was then monitored for styrene autoxidation. See FIG. 7. As can be observed, the NCeONP macro-structures herein shows the overall best antioxidant activity against the autoxidation of styrene when utilized in combination with the representative co-antioxidant γ-terpinene.

To further evaluate and confirm the antioxidant activity of the NCeONP macro-structures herein, a comparison was made to evaluate the ability of the NCeONP macro-structures to accept hydrogen atoms. That is, a comparative evaluation was made of the reaction NCeONP macro-structures with respect to the other indicated metal oxides, with tert-butylhydroquinone as the hydrogen-donor. The reaction was monitored by UV spectroscopy in acetonitrile solution under nitrogen (N₂).

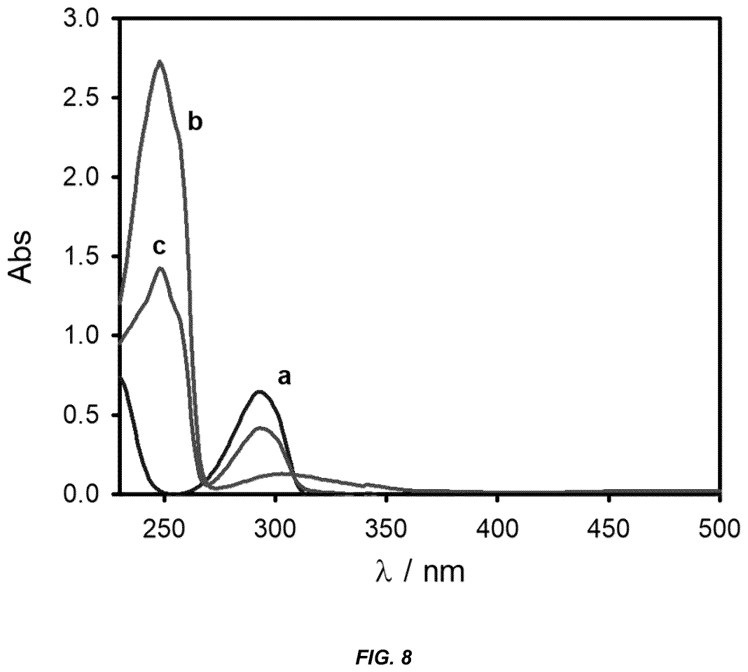

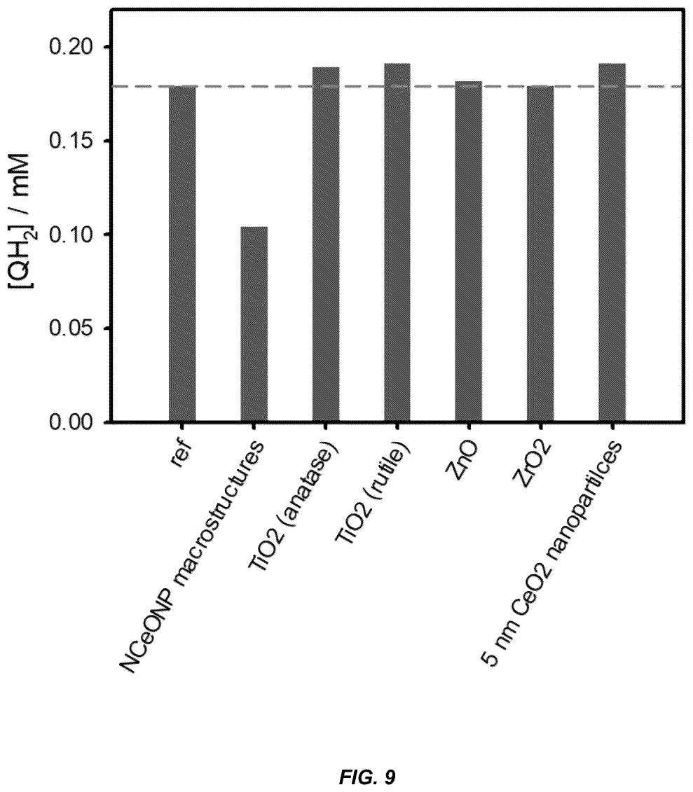

Attention is first directed to FIG. 8 which provides in plot “a” the UV absorption of: tert-butylhydroquinnone ((labelled QH₂) at 0.18 mM. Plot “b” is for the identified quinone structure (labelled Q) at 0.18 mM, and plot “c” is the UV absorption of the mixture QH₂ and NCeONP macro-structures herein at 0.18 mM/1 mg/ml after four (4) hours of reaction. Using this approach with the other metal oxides, attention is directed to FIG. 9, which provides the relative concentration of the indicated compounds after reaction with QH₂. The listing of “ref” in FIG. 9 indicates the QH₂ initial concentration. The reference to cerium oxide nanoparticles is again reference to 5 nm size particles.

The results from FIGS. 8 and 9 show that the NCeONP macro-structures herein is relatively more oxidizing among the identified metal oxide. The equilibration onset between the NCeONP macro-structures herein and QH₂ suggests that the bond dissociation energy of a hydrogen in the NCeONP macro-structures is comparable to the mean bond dissociation energy of the hydrogen on the —OH group in QH₂ that is estimated at 74 kcal/mole, while the other identified metal oxides have a bond dissociation energy of a hydrogen therein that is less than 70 kcal/mole. Accordingly, the bond dissociation of a hydrogen in the NCeONP macro-structures appears to be higher than that of the hydrogen in HOO·, (55 kcalmole) and at the same time is smaller than that of the hydrogens in ROO—H or HOO—H (85 kcal/mole), where thereby makes it possible to close the catalytic cycle in Scheme 2 above.

1. An autoxidation composition to inhibit autoxidation of an organic compound susceptible to autoxidation comprising:
a. a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm; and
b. a co-antioxidant compound comprising an organic compound hydrogen donor that provides for an abstraction of hydrogen by a peroxy radical ROO·, where R is reference to organic alkyl or organic aromatic type functionality.

2. The autoxidation composition of claim 1 wherein said co-antioxidant compound is selected from the group consisting of pro-aromatic compounds, organic alcohol compounds, hydroquinone compounds, unsaturated hydrocarbon compounds, primary, secondary and tertiary alkylamine compounds, 1,4-dihydropyridines, 4-substituted Hantzsch ester, 2,3- and 2,5-dihydrofurane, 1,2- and 1,4-dihydronaphthalene.

3. A stabilized composition comprising:
a. a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm; and
b. a co-antioxidant compound comprising an organic compound hydrogen donor that provides for an abstraction of hydrogen by a peroxy radical ROO·, where R is reference to organic alkyl or organic aromatic type functionality
c. an organic compound susceptible to autoxidation.

4. The stabilized composition of claim 4 wherein said cerium oxide nanoparticles present as a macro-structure are present in said organic compound susceptible to autoxidation at a level of 0.1% (wt.) to 5.0% (wt.).

5. The stabilized composition of claim 4 wherein said co-antioxidant is present is said organic compound susceptible to autoxidation at a level of 0.1% (wt.) to 5.0% (wt.).

6. The stabilized composition of claim 4 wherein said organic compound susceptible to autoxidation comprises a polymer.

7. The stabilized composition of claim 6 wherein said polymer comprises a polymer that includes one or more tertiary, secondary or primary hydrogen atoms.

8. The stabilized composition of claim 6 wherein said polymer comprises polyethylene, polypropylene, poly(vinyl chloride), polyisoprene, polybutadiene, or polystyrene.

9. A method for reducing the autoxidation of an organic compound susceptible to autoxidation, comprising:
supplying nanoporous cerium oxide nanoparticle (NCeONP) macro-structure comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm;
supplying a co-antioxidant compound comprising an organic compound hydrogen donor that provides for an abstraction of hydrogen by the free radical ROO· and R is reference to organic alkyl or organic aromatic type functionality; and
placing said nanoporous cerium oxide nanoparticle macro-structure and said co-antioxidant into said organic compound susceptible to autoxidation to reduce autoxidation.

10. The method of claim 5, wherein said nanoporous cerium oxide nanoparticle (NCeONP) macrostructure is present at a level of 0.1% (wt.) to 5.0% (wt.) in said organic compound susceptible to autoxidation.

11. The method of claim 5 wherein said co-antioxidant is present at a level of 0.1% (wt.) to 5.0% (wt.) in said organic compound susceptible to autoxidation.

12. The method of claim 5 wherein said co-antioxidant is selected from the group consisting of pro-aromatic compounds, organic alcohol compounds, hydroquinone compounds, unsaturated hydrocarbon compounds, primary, secondary and tertiary alkylamine compounds, 1,4-dihydropyridines, 4-substituted Hantzsch ester, 2,3- and 2,5-dihydrofurane, 1,2- and 1,4-dihydronaphthalene.

13. The method of claim 5 wherein said organic compound susceptible to autoxidation comprises a polymer containing a tertiary, secondary or primary hydrogen atom that is susceptible to abstraction by a free-radical.

14. The method of claim 9 wherein said polymer comprises polyethylene, polypropylene, poly(vinyl chloride), polyisoprene, polybutadiene, or polystyrene.
